(19) United States
(12) Patent Application Publication
(10) Pub. No.: US 2016/0208771 A1
(43) Pub. Date: Jul. 21, 2016

(54) Double Acute Angle Hydro and Wind Turbine

(71) Applicant: George David Hughes, Chapel Hill, NC (US)

(72) Inventor: George David Hughes, Chapel Hill, NC (US)

(21) Appl. No.: 15/085,425

(22) Filed: Mar. 30, 2016

(51) Int. Cl. F03B 17/06; F03D 5/00

(52) U.S. Cl. CPC F03B 17/06; F03D 5/00

(57) ABSTRACT

An efficient low flow, low head, undershot double acute angle turbine where the flow strikes the blades at 90° without the Betz limit. Blades are set at an acute angle to the axle and the turbine is positioned in the flow at the compliment of the blade angle. There is no lag on downstream blades. There is no turbulence when the idle blade enters the flow. Active blades exhaust to the next blade to extract more energy. Simple adjustments set the flow to the blade tip that will produce the highest rotational speed. It is portable. It can be scaled up for larger applications by adding blades to the axle or using longer blades. It can be made from repurposed materials using hand tools. Hydro installations include in a sluice and on a floating barge. It has been tested successfully in flowing water and wind.

### BACKGROUND OF THE INVENTION

1. Field of the Invention

The invention pertains to hydro and wind turbines. More specifically, the invention pertains to an undershot, low head and low flow water turbine that functions also as a wind turbine.

2. Description of Related Art

Hydro and wind turbines are either axial flow or cross-flow turbines. Propeller turbines are axial flow because the flow is along the axle. According to the Betz equation, their efficiency cannot exceed 59.26% because the flow cannot strike a blade at 90°, the most powerful angle. A direct strike would stop the rotation.

Cross-flow hydro turbines have the flow across the axle. The large wheel at a grist mill is a cross-flow turbine. Cross-flow turbines have efficiencies of 85% to over 95%. The Turgo turbine has an efficiency in the high 90s, but it requires a head of 50 to 250 meters. The Banki-Michell turbine achieves 85% efficiency, but it requires precise jets and blades and a heavy, permanent installation. The efficiency of the Francis turbine exceeds 90%, but it requires a head of 130 to 2,000 feet. The Kaplan turbine modifies the Francis turbine so that it has a higher efficiency and requires a lower head, 10 to 70 meters. A complete review of turbine characteristics may be found in Wikipedia articles on “Water Turbine” and “Water Wheel”.

Darrieus-type turbines (U.S. Pat. No. 1,835,018) have the advantages of striking the blade at 90° and being omnidirectional, but they suffer from lag. Lag is when the idle blades are in the downstream position so the flow strikes the back of the blade, forcing a backward rotation. The net efficiency of this type of turbine is the positive thrust minus the lag. There have been many inventions to reduce or eliminate lag (U.S. Pat. No. 4,838,757; 2014/0,023,500; 2014/0,140,812; 2014/0,217,738; and Foreign Pat. No. EP 2,667,016; KR 1014/18,011; WO 2015/034,096; WO 2014/132,842).

Cross-flow turbines can have the flow strike the blades above the axle, at the axle, or below the axle. They are called overshot, breast shot, or undershot turbines. The grist mill is an overshot turbine. Its flow uses only 25% of the blade surfaces.

In 300 BC the Greeks invented the undershot turbine, which was also called the ship turbine because it was a wheel on a ship that was anchored in a river. As the blades entered the flow there was a turbulence, which reduced the efficiency. In 1823 Poncelet used curved blades to reduce this turbulence. It produced an efficiency of 70% to 80%, as noted in a Wikipedia article on the “Poncelet Wheel”. The 70% occurred when the flow was so high it overflowed the buckets. This problem will not occur in the present invention because it uses blades, not buckets. The Poncelet undershot turbine equaled the efficiency of the overshot turbine. The overshot turbine requires more head than the undershot turbine, 2 to 10 meters versus fewer than 2 meters, as reported by M. Denny, “The efficiency of overshot and undershot waterwheels,” Institute of Physics Publishing, European Journal of Physics, Vol. 25 (2004) 193-202. Thus, the undershot turbine can be used in more locations than an overshot one.

### SUMMARY OF THE INVENTION

The health and economies of remote villages would benefit from a constant source of power. This invention would drive machines such as water pumps, flour mills, and alternators to charge batteries for LED lighting, computers for education and entertainment, phones, refrigeration for pharmaceuticals, and farm equipment, which uses expensive fuel or animal power that requires food and creates CO2.

This patent describes a low-head, low-flow, undershot water turbine that can be used also as a wind turbine. It can be built from repurposed materials using hand tools. It drives off-the-shelf alternators. It is easy to maintain. It can be shifted without modification from water to wind to meet changing weather and political conditions. It is portable. It does not disrupt down-stream cultures, fish migration, or boat navigation.

This invention differs from existing turbines because it is neither an axial nor a cross-flow turbine. It is a tangential flow turbine where the acute angle of the flow to the axle and the complimentary acute angles of the blades to the axle add to 90° for a maximum thrust. This 90° thrust is achieved very simply. The blades on the axle are set an acute angle to the axle. The turbine is installed in the flow at an angle that is the complimentary angle of the blades. The sum of these two acute angles is 90°. FIG. 1 illustrates this arrangement in an actual test where the blades were 45° to the axle and the turbine was positioned at 45° into a sluice flow.

Output can be increased by adding blades along the axle instead of increasing the length of the blades, as required with other turbines. This feature makes it more compact for portability and easier installation and maintenance,

This is an undershot turbine but it does not have the turbulence problem because the blades enter parallel to the flow and then rotate into 90° of the flow. Because power is created at the tip of the blades, the invention has an easy adjustment for raising or lowering the axle so that rotational speed can be maximized for the available flow rate. Lowering the axle floods the blades and slows the rotation. There is no lag problem from idle blades because they are out of the water until they move into the forward thrust position. The present turbine is more efficient than the Poncelet turbine that uses the flow only once and then exhausts it back to the stream. In the present turbine the blades exhaust the flow to the next blade in the rotation to extract more energy before returning the flow to the stream. This use of exhaust is shown in FIG. 4.

This is primarily an impulse turbine, as defined in Newton's second law.

### BRIEF DESCRIPTION OF THE DRAWING

FIG. 1 shows a side view of various aspects of the sluice embodiment of the test model of the double acute angle turbine where the flow was 45° into the axial and the blades were 45° into the axial, thereby producing a 90° thrust.

FIG. 2 shows a side inside view of the right vertical adjustment assembly.

FIG. 3 shows an end outside view of she right vertical adjustment assembly.

FIG. 4 shows a side view of a 45° flow as it impacts blades at four different positions illustrating exhaust effects.

### DETAILED DESCRIPTION OF THE INVENTION

### First Embodiment, Hydro Turbine in a Sluice

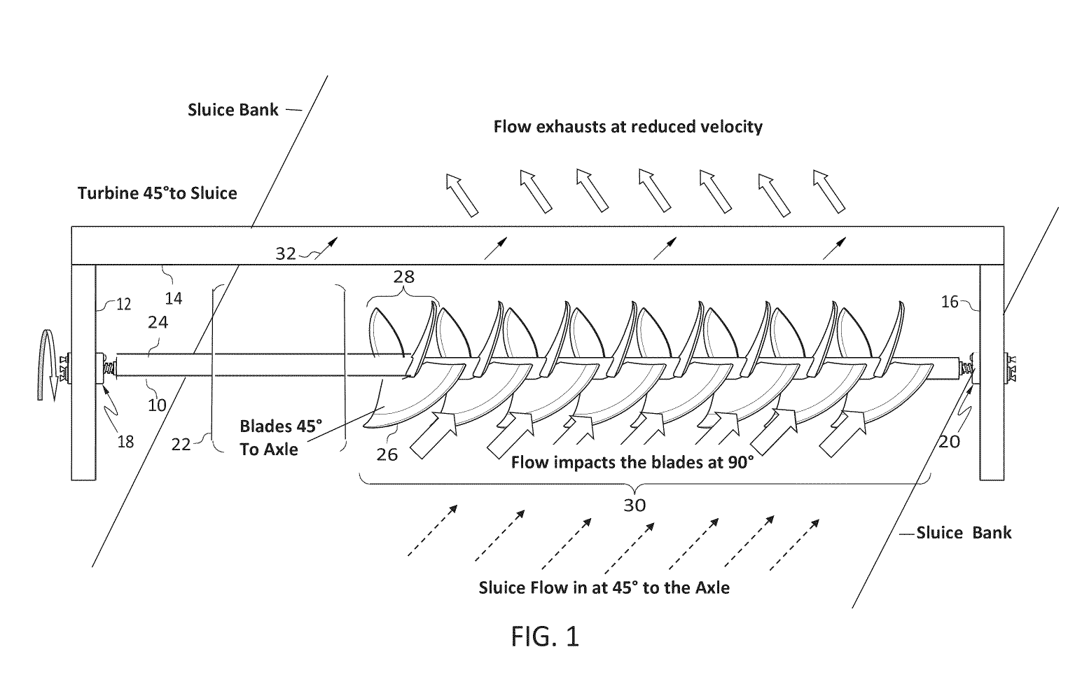

The sluice embodiment in FIG. 1 (side view) shows only one of countless combinations of materials, blade arrangements, and blade and flow angles that may be used to adapt this turbine to meet local conditions. It illustrates blades (26) at 45° to the axle. When a turbine is installed in a water or air flow parallel to the 45° flow angle indicator (32), the flow is at 45° to the axle. The flow then strikes the blade at 90°. Tests confirmed that any flow angle more or less than 45° slowed the rotation. A flow parallel to the axle stopped the rotation.

In the test, each blade cluster (28) had 4 quadrant blades. There were six clusters (30) in the test, but more clusters can be added (22) to increase the output. Longer blades can be used for more output. It is smaller and quieter than other turbines.

The preferred embodiment shown in FIG. 1 is to install the turbine in a sluice for easy installation and maintenance. It is easy to guard and camouflage when in hostile political environments. By extending the axle for the power take off (24), the electrical equipment is on land to keep it dry. A sluice can be curved to create a Venturi effect, which increases the velocity of the flow to increase the power output. The entrance to the sluice has a screen to divert fish and debris. The sluice has a gate to control the flow rate.

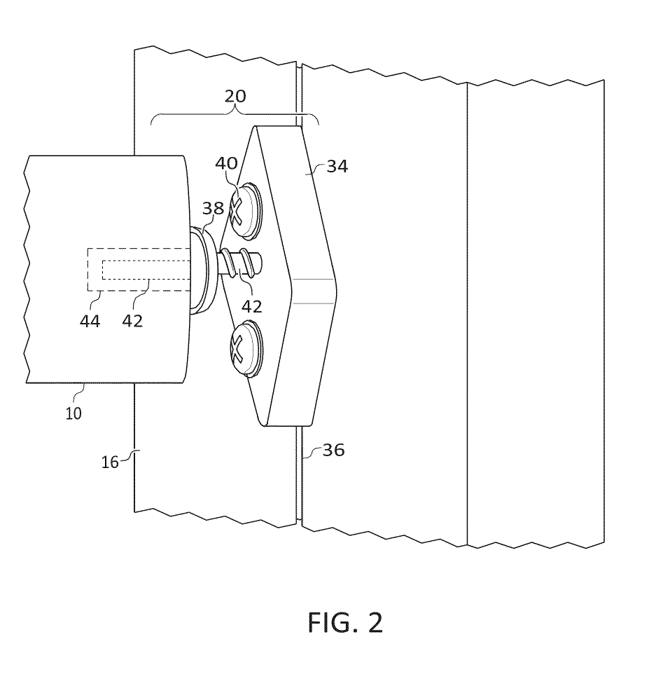

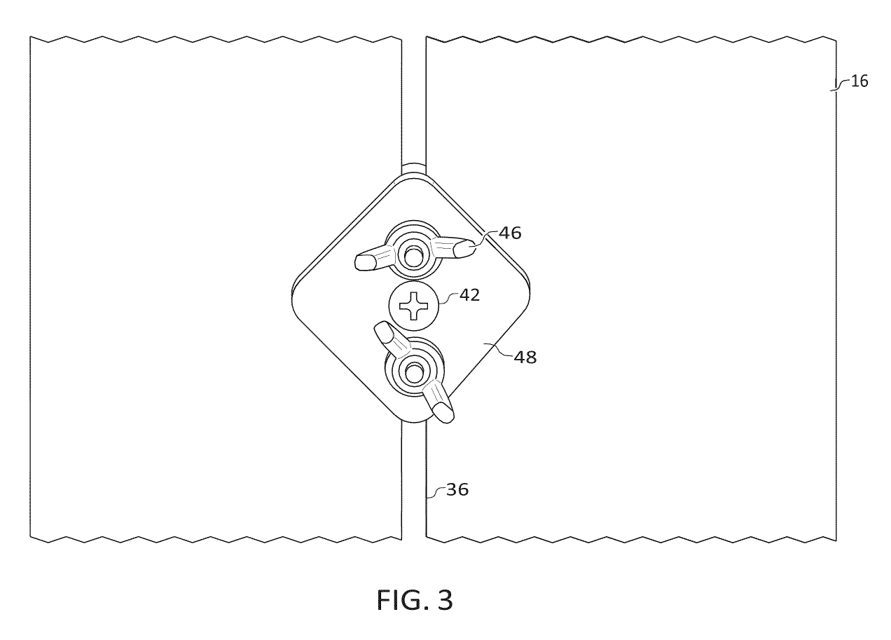

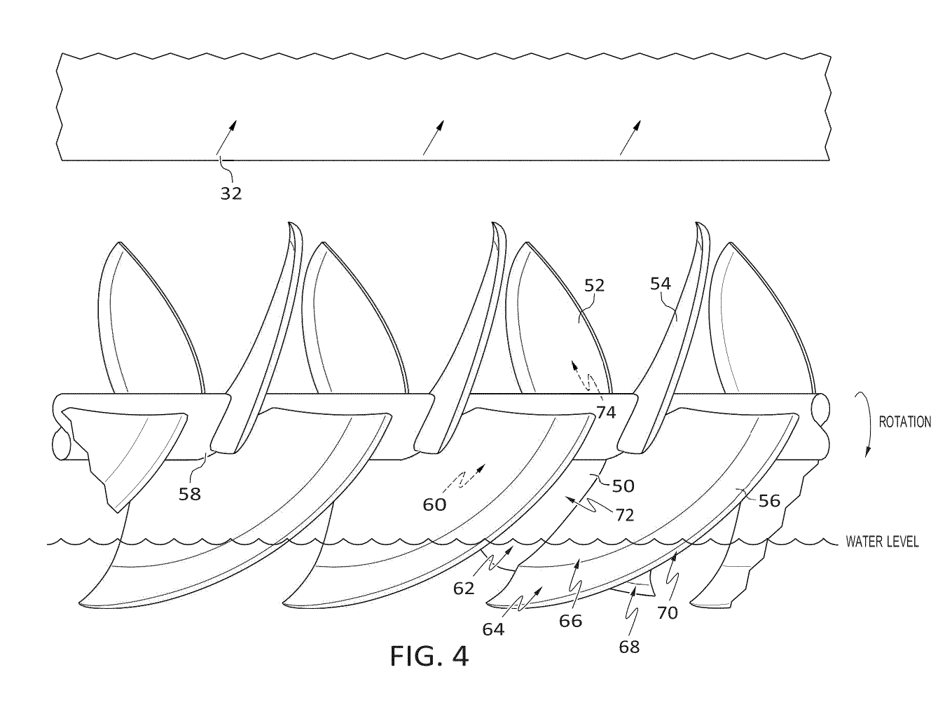

The axle, left support, connecting board/handle, and right support (10, 12, 14, and 16) can be made of material that resists rot, such as pressurized wood, aluminum, or plastic. The test model used pressurized wood and aluminum. The test turbine was made with a hand saw, a hand drill and bits, and a screw driver. The blades shown were made from repurposed pizza pans. The 5% curve at the blade tip reduced tip leakage to extract more power from the flow. The curve also helps exhaust the flow to the next blade. As will be seen in FIG. 4, this curve also induced a small lift reaction. The left and right vertical axle adjustment assemblies (18, 20, FIG. 2, and FIG. 3) are inexpensive screws, wing nuts, tubing, and washers.

FIG. 2 illustrates the inside of the right vertical adjustment assembly (20). This adjustment is necessary to keep the flow at the bottom tip of the blade for the highest rotational speed. A higher water level floods the blade and slows the turbine. The adjustment assembly is made from inexpensive parts that are held by a wood block (34). The axle (10) rotates around a wood screw (42) that is inserted in a tube in the axle (44). The tube is made of rust resistant material such as copper. Thrust bearings are simply washers (38). These parts can be replaced quickly as they wear. Machine screws (40) pass through vertical slots (36) in the end board (16) to the outside of the adjustment cluster (FIG. 3). An alternative to this hardware bearing assembly is oil soaked wood bearings that can be made locally, as described in Practical Action, “Oil Soaked Wood Bearings, How to Make Them and How They Perform,” http://practicalaction.org/jobs/does/technical_information_services/oil_soaked_wood_bearings.pdf, Mar. 21, 2016.

FIG. 3 illustrates the end view of the outside of the right vertical adjustment assembly. By loosening the wing nuts (46), the axle can be raised or lowered without tools so that the flow strikes the bottom of the blades for the highest rotational speed. The depth of the blade into the flow for the highest rotational speed will depend on the head and the velocity of the stream flow. When the turbine output is attached to an alternator, the operator can determine the ideal depth precisely with a volt meter.

### Operation

### FIG. 4

FIG. 4 shows a close-up of a blade cluster to explain how this turbine uses neither a cross flow nor an axial flow.

When the blade in the idle 12 o'clock position (54), it is out of the water, so it is not subject to lag like the Darrieus-type turbines. In the 3 o'clock position (56), it enters parallel to the flow so there is no turbulence. As the 3 o'clock blade rotates toward the bottom 6 o'clock position, the flow splits with some of the flow in front of the blade and some in back (65). This flow split causes an impulse force on the front of the blade and a reaction lift force on the curve of the back of the blade. Both of these forces are positive so there is no lag effect. The sloping angle of the blade in the 3 o'clock position exhausts the flow (72) to the next blade (50) in the 6 o'clock position. Using the blade exhaust makes this invention more efficient than the Poncelet undershot turbine, which uses the flow only on one blade. The blade in the 6 o'clock position will receive the 90° flow thrust (60, 62, and 68). As the 6 o'clock blade rotates it will exhaust to the blade in the 9 o'clock position (74). The direct and the exhaust flow put a force on over 50% of the blade surfaces. The set screw (58) enables easy assembly and quick replacement of a blade. The slot (59) is cut into the axle at the specified acute blade-to-axle angle. The rotation of the test model was counter-clockwise but it can be clockwise if the attached machine requires it.

Said hydro turbine has been tested successfully in a creek where the flow rate was reported by the USGS.

### Alternative Embodiment

Mounting the turbine on an anchored barge with a keel maintains the angle of the flow on the axle and the proper blade depth. It is more portable because it does not require digging a sluice. Its disadvantages include: it must be pulled ashore for maintenance and charging batteries, it cannot be camouflaged easily, electrical systems must be waterproofed, and it is vulnerable to floating logs and boats at night.

### Second Embodiment, Wind Turbine

Without any modifications, said turbine tested successfully in a horizontal position on land using a variable speed fan, a digital anemometer, and a digital tachometer. As a wind turbine it could be used when there is wind but no water flow. Its portability makes it easy to install. It can be put on a hill, the top of a building, or a platform with a vane to function like a weather vane to keep the flow at the designed flow angle. In contrast, the installation of a propeller wind turbine requires a tall pole that is higher than the length of a blade, which makes installation and maintenance expensive. Because the flow strikes the blades at 90°, this invention's efficiency exceeds the Betz limit of 59.26%. The test model reached 70%.

### Alternative Embodiment

This turbine can be used as a vertical wind turbine so long as the flow is at the designed angle. The test model worked with the turbine upright at 45° into the flow.

### Advantages

Accordingly, the undershot double acute angle turbine has several advantages of one or more aspects, as follows: it operates with a low head, it does not require a dam or weir, its flows strike blades at 90° for maximum thrust without the Betz efficiency limit, its portability permits moving it to optimal points in a sluice or a stream, its portability enables moving for nomadic cultures and away from political strife, it can be used as a hydro or a wind turbine, it can be made from repurposed materials using hand tools, and its output can be increased easily by adding blade clusters or by increasing the length of the blades. Its design simplicity makes it easy to scale up for larger installations where more traditional designs are being considered. Other advantages of one or more aspects will be apparent from a consideration of the drawings and ensuing description.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

TABLE OF REFERENCE NUMERALS

| | |
|---|---|
| 10 | Axle |
| 12 | Left support |
| 14 | Connecting board/handle |
| 16 | Right support |
| 18 | Left axle vertical adjustment assembly |
| 20 | Right axle vertical adjustment assembly |
| 22 | Space for additional blade cluster |
| 24 | Rotary power take off |
| 26 | Blade, 45° in test model |
| 28 | Cluster of 4 blades in this example |
| 30 | Six clusters in this example |
| 32 | Angle of flow indicator, 45° in test model |
| 34 | Right axle vertical adjustment inside block |
| 36 | Right axle vertical adjustment slot |
| 38 | Right axle adjustment assembly washers |
| 40 | Adjustment assembly machine screw |
| 42 | Wood screw |
| 44 | Copper tube |
| 46 | Wing nut for machine screw |
| 48 | Right axle vertical adjustment outside block |
| 50 | Blade at 6 o'clock 90° flow position |
| 52 | Blade at 9 o'clock position |
| 54 | Blade at 6 o'clock position |
| 56 | Blade at 3 o'clock position |
| 58 | Set screw for blade replacement |
| 59 | Slit in said axle at specified acute angle to said axle when blade in 6 |
| | o'clock position |
| 60 | Flow strikes 6 o'clock blade at 90° |
| 62 | Flow strikes 6 o'clock blade at 90° |
| 64 | Flow starts strike on 3 o'clock blade |
| 66 | Flow front and back of 3 o'clock blade |
| 68 | Flow on end of 6 o'clock blade |
| 70 | Flow continues on 3 o'clock blade |
| 72 | Blade 56 exhausts into Blade 50 |
| 74 | Blade 50 exhausts into Blade 52 |

What is claimed is:

1. An undershot turbine for converting a linear fluid flow into radial power, comprising:
a) a plurality of end plates;
b) a plurality of bearings mounted to the end plates at an adjustable height set by a mechanism for raising and lowering;
c) an axle having a rotational axis, rotatably supported by the bearings; and
d) a plurality of blades set into the axle at an acute angle relative to the rotational axis of the axle.

2. The turbine of claim 1, further comprising at least one connecting board supporting the plurality of end plates.

3. The turbine of claim 2, further comprising at least one flow indicator on the at least one connecting boards for showing a required flow direction and a required angle of the flow, wherein said flow angle is complimentary to the acute angle of the blades.

4. The turbine of claim 1, in which the fluid is a liquid.

5. The turbine of claim 4, in which the liquid is water.

6. The turbine of claim 1, in which the fluid is air.

7. The turbine of claim 1, further comprising a sluice for guiding the flow of fluid across the turbine at flow angle which is complimentary to the acute angle of the blades.

8. The turbine of claim 1, in which the each of the end plates has a slot for adjustably mounting the bearings, and the mechanism for raising and lowering comprises:
a) a mounting block supporting a bearing;
b) a plurality of threaded fasteners passing through the mounting block and the slot in the end plate; and
c) a tightener threaded to each of the threaded fasteners on an opposite side of the end plate from the mounting block.
